(19) United States
(12) Patent Application Publication
(10) Pub. No.: US 2010/0069536 A1
(43) Pub. Date: Mar. 18, 2010

(54) Process for tailoring water-borne coating compositions

(76) Inventor: Arjun C. SAU, Newark, DE (US)

Correspondence Address: Robert O'Flynn O'Brien;Hercules Plaza, 1313 North Market Street, Wilmington, DE, 19894-0001, US

(21) Appl. No.: 12/495,920

(22) Filed: Jul. 1, 2009

Related U.S. Application Data
(60) Provisional application No. 61/135,185, filed on Jul. 17, 2008.

(51) Int. Cl. C09D 133/00; C09D 133/26; C09D 175/04; C09D 171/00; C09D 105/00

(52) U.S. Cl. 524/48; 524/800; 524/832; 524/827; 524/839; 524/27; 524/446; 524/423; 524/430; 524/456; 524/451; 524/413; 524/432

(57) ABSTRACT

The present invention relates to a process for tailoring theology of an aqueous or water-borne coating composition using a system comprising an amount of a first hydrophobically modified polymer comprising a polymer backbone modified with a first hydrophobe and an amount of a second hydrophobically modified polymer comprising the first hydrophobically modified polymer further modified with a second hydrophobe. By incorporating a system comprising at least two hydrophobically modified polymers into water-borne coatings where the amount of all of the hydrophobically modified polymers are able to be independently adjusted, the resultant coatings may be tailored to attain a desired combination of Stormer or Brookfield viscosity and ICI viscosity.

### RELATED APPLICATIONS

This application claims the benefit of U.S. Provisional Application Ser. No. 61/135,185, filed on Jul. 17, 2008, which is incorporated herein by reference in its entirety.

### FIELD OF THE INVENTION

This invention relates to thickening aqueous or water-borne coating systems using polymeric systems. More particularly, this invention relates to a process for tailoring rheology of aqueous or water-borne coating compositions using a system comprising at least two hydrophobically modified polymers where one of the hydrophobically modified polymers is modified with more than one type of hydrophobe.

### BACKGROUND OF THE INVENTION

Aqueous coating compositions, such as water-borne coatings are complex mixtures of binders, pigments, dispersants, defoamers, surfactants, biocides, preservatives, coalescing aids, neutralizing agents, colorants, humectants and thickeners. In addition, oftentimes optional ingredients are added to the coating formulations to achieve specific desired paint properties.

While in the market place traditional thickeners are still used to thicken water-borne coatings, they do not provide certain desired rheological properties for high quality coatings. To meet these requirements, in the last three decades, a new class of water-soluble polymers called hydrophobically modified water-soluble polymers (HM-WSPs) has been developed and commercialized to the coatings industry (see E. J. Schaller and P. R. Sperry, in “Handbook of Coatings Additives”, Ed. L. J. Calbo, Vol. 2, p.: 105, 192; Marcel Dekker, Inc., New York). HM-WSPs are water-soluble or water-swellable polymers bearing a small amount of a hydrophobe. The presence of hydrophobic moieties in HM-WSP chains makes the latter undergo non-specific association with themselves or with other

[symbol]

Three classes of HM-WSPs are currently available as rheology modifiers. These are: a) Hydrophobically modified nonionic cellulose ethers (HM-NCEs), b) Hydrophobically modified nonionic synthetic polymers (HM-NSPs), and c) Hydrophobically modified anionic polyacrylates (HM-APAs).

U.S. Pat. Nos. 4,228,277, 4,352,916, 4,845,207, 4,902,733, 5,290,829, and 6,362,238 disclose the preparation of HM-NCEs and their use as thickeners, emulsifiers, and stabilizers for latex compositions; the disclosures of which are incorporated herein by reference in their entireties. In these polymers, the hydrophobe grafted to the cellulose ether backbone is an alkyl group bearing 6-24 carbon atoms.

HM-NSPs bearing urethane linkages (hereafter referred to as “urethane-linkage-bearing HM-NSPs”) are disclosed in a number of publications (see for examples, U.S. Pat. Nos. 4,079,028, 4,155,892, 4,298,511, 4,327,008, 4,337,184, 4,373,083, 4,499,233, 4,426,485, 4,496,708, 5,023,309, 5,281,654, and 5,496,908), the disclosures of which are incorporated herein by reference in their entireties. A common chemical feature of these HM-NSPs is that they have synthetic water-soluble polymer blocks interconnected by small hydrophobic segments of a urethane residue and the chain termini are capped with identical hydrophobic groups. The hydrophilic blocks are typically polyalkylene oxides.

Several types of HM-NSPs bearing no urethane linkages (hereafter referred to as “non-urethane HM-NSPs”) are also known. They are: a) hydrophobically modified polyether polyols, b) hydrophobically modified aminoplast polyethers and c) hydrophobically modified poly(acetal- or ketal-polyethers).

Compositions of hydrophobically modified polyether polyols are disclosed in U.S. Pat. Nos. 4,288,639, 4,354,956, 4,411,819, 4,673,518,

[symbol]

Hydrophobically modified aminoplast polyethers are condensates of polyethers with aminoplasts and are described in U.S. Pat. Nos. 5,627,232, 5,629,373, 5,914,373 and WO 01/127/12712, the disclosures of which are incorporated herein by reference in their entireties.

Compositions of hydrophobically modified poly(acetal- or ketal-polyethers) are disclosed in U.S. Pat. Nos. 5,574,127 and 6,162,877, the disclosures of which are incorporated herein by reference in their entireties. They are prepared by copolymerizing an alpha,omega-diol, -thiol, or -diamino polyether with a dihalogeno-compound in the presence of a base to form an alpha,omega-diol, -thiol, or -diamino poly(acetal- or ketal-polyether) which in turn is reacted with hydrophobic reagents to form a hydrophobically modified poly(acetal- or ketal-polyether). These HM-WSPs are used as rheology modifiers in aqueous formulations, such as water-borne coatings. They are particularly useful for thickening aqueous systems having high pHs (>8) and exposed to above 25° C.

Random mixed hydrophobe modified polyethylene glycols made by reacting polyethylene glycols with alk(en)yl succinic anhydrides are disclosed in U.S. Pat. No. 6,743,855, the disclosure of which is incorporated herein in its entirety. The number average molecular weight of the polyethylene glycol ranges from 200 to 35000 and the alk(en)yl group contains no more than 30 and especially no more than 20 carbon atoms. The ester linkages present in these polyester based polymers are, however, susceptible to hydrolysis to undergo molecular degradation under alkaline environment (pH>7) when they are stored in solution for a long time. Due to the detachment of the hydrophobic groups from the polymer backbone upon storage at pH>7, they lose their hydrophobically associative properties or viscosifying abilities above room temperature and

[symbol]

In formulating water-borne coatings, an appropriate balance of low- and high-shear viscosity (e.g., Stormer viscosity and ICI viscosity) is sought to deliver a satisfactory application properties. One of the problems with existing HM-WSPs is that a single polymer does not often provide the desired low- and high-shear rheology, i.e., Stormer viscosity and ICI viscosity. Generally, HM-WSPs, particularly HM-NSPs, that offer efficient in building Stormer viscosity are not efficient providers of ICI viscosity. In such cases, water-miscible organic solvents are added to coating formulations to reduce the efficiency of Stormer viscosity buildup and incorporate more HM-NSPs to increase ICI viscosity. Regrettably, the use of organic solvents in water-borne coatings is undesirable as they are environmentally unacceptable. After the coatings are applied on the substrate, organic solvents are eventually released to the atmosphere causing environmental pollution and human health problems.

Prior efforts to deliver a balance of rheological properties by using a combination of urethane-linkage-bearing HM-NSPs and HM-APAs made by copolymerizing a mixture of ethylenically unsaturated monomers are described in U.S. Pat. Nos. 4,507,426 and 4,735,981, the disclosures of which are incorporated herein by reference in their entireties.

The use of a mixture of urethane-linkage-bearing HM-NSPs in combination with a surfactant co-thickener and a nonaqueous, inert organic solvent to thicken print paste is described U.S. Pat. No. 4,180,491, the disclosure of which is incorporated herein by reference in its entirety.

Howard et al. in a publication (P. R. Howard, E. L. Leasure, S. T. Rosier and E. J. Schaller, Journal of Coatings Technology, Vol. 64, No. 804, January 1992) describe the use of a combination of urethane-linkage-bearing HM-NSPs to achieve a balance of desired low- and high-shear viscosity without using co-solvents or surfactants. They also recommend the use of other polymers in combination with urethane-linkage-bearing HM-NSPs to achieve a

[symbol]

U.S. Pat. No. 5,118,749 describes the improvement of ICI viscosity of an acrylic latex paint without using a rheology modifier. U.S. Pat. No. 5,219,917 discloses a latex paint capable of exhibiting improved ICI viscosity by incorporating a polymeric binder that comprises about 95-99.5 wt % of a high molecular weight film former and about 0.5-5 wt % of a particular polymer made from a vinyl, acrylic, acrylamide and/or an alkadiene monomer.

To improve sag resistance of water-borne coatings, particularly, latex paints, and the use of a mixture of different HM-NCEs is disclosed in U.S. Pat. No. 5,281,654, the disclosure of which is incorporated herein in its entirety.

U.S. Pat. No. 6,107,394 discloses the incorporation of a blend of a non-urethane HM-NSP and a urethane-linkage-bearing HM-NSP into latex paints to efficiently increase their low-(Stormer viscosity) and high-shear viscosity (ICI viscosity), the disclosure of which is incorporated herein in its entirety.

In tinted water-borne coatings, various colorants are used to achieve a particular color. Certain colorants used in the formulation sometimes do not completely disperse in the base paint due to their poor compatibility with the coatings ingredients. Consequently, poor color development occurs. The degree of color development is tested by applying the coatings with a doctor blade and subjecting the drawdown to high shear stress by finger-rubbing a small area of the partially dry film. The shearing action tends to disperse undeveloped colorant, if any, and produces a color variation between the unsheared and sheared regions of the paint film. The color variation is measured colorimetrically to give a numerical color difference value that measures the color development of the original paint. The smaller the difference in the numerical color difference value, the better the color development of the paint. For details of color development test method, see ASTM D5326-94a (2002) Standard Test Method for Color Development in Tinted Latex Paints. It has been disclosed in U.S. Pat.

[symbol]

The preparation of mixed hydrophobe modified poly(acetal or ketal-polyethers) and having low bulk density and delivery of these polymers as aqueous suspensions have been disclosed in U.S. Pat. No. 6,369,132. When diluted with water, these polymeric aqueous suspensions dissolve rapidly without lumping.

Currently, coatings formulators use multiple thickeners to achieve a balance of rheological properties. While this approach works in selected systems, the use of multiple thickeners is expensive, cumbersome, time-consuming and can also adversely affect other rheological properties, such as stability, spattering flow and leveling, hiding and dry film properties, such as gloss, corrosion resistance, etc. Storage, handling, dosing and management of multiple thickeners at coatings manufacturing site add complexity and cost to the manufacturing process. The problem is exacerbated if the thickeners to be used (a) belong to different chemical classes, (b) are delivered in different physical forms (powder, solution or dispersion) or (c) are chemically incompatible.

Chemical incompatibility means interactions between chemically dissimilar thickeners in conjunction with formulation ingredients leading to non-homogeneity or appearance of multiple phases (syneresis) in the formulated coatings. By being incompatible, they can adversely affect coating properties, such as stability, spattering, flow and leveling, hiding and gloss.

Another issue with the use of chemically dissimilar thickeners is their physical form—powder versus liquid form. Thickeners delivered in liquid form are easy to meter and, if needed, can be post-added to formulated coatings to increase (adjust) their Stormer viscosity. By contrast, thickeners delivered in powder form are difficult to incorporate into formulated coatings as they tend to form gels or insoluble masses.

Accordingly, there is a need in the coatings industry for a thickener or rheology modifier system that provides both the desired Stormer viscosity and good film build without adversely affecting other paint properties.

It is an object of the present invention to provide rheology modifier systems that imparts a combination of desired Stormer viscosity and ICI viscosity when incorporated into water-borne coatings.

### BRIEF DESCRIPTION OF THE INVENTION

It was surprising to find that by incorporating a system comprising at least two hydrophobically modified polymers wherein one of the hydrophobically modified polymers is modified with more than one type of hydrophobe into water-borne coatings and the amounts of both of the hydrophobically modified polymers are able to be independently adjusted, the Stormer viscosity and ICI viscosity of coatings could be significantly enhanced. By selecting appropriate hydrophobes and their amounts grafted onto their respective base polymers, a balance of the Stormer viscosity and ICI viscosity could be achieved in water-borne coatings. These mixed hydrophobe modified polymer systems may comprise blends of at least two hydrophobically modified polymers thereby allowing coating formulators to tailor the balance of Stormer and ICI viscosity and other theological properties, such as flow, leveling, spatter resistance and ability to suspend the dispersed phase of the coating composition.

The present invention relates to a process for tailoring rheology of an aqueous or water-borne coating composition using a system comprising an amount of a first hydrophobically modified polymer comprising a polymer backbone modified with a first hydrophobe and an amount of a second hydrophobically modified polymer comprising the first hydrophobically modified polymer further modified with a second hydrophobe. The first hydrophobe and the second hydrophobe are different from each other. The amount of the first hydrophobically modified polymer is selected relative to the amount of the second hydrophobically modified polymer to tailor the rheology of the aqueous or water-borne coating composition.

The aqueous or water-borne coating composition is combined with an amount of the polymer systems to obtain an aqueous or water-borne coating composition with a tailored rheology.

These mixed hydrophobe modified polymers may be produced by grafting hydrophobes of different types onto synthetic polymers, natural polymers and modified natural polymers or semi-synthetic polymers.

Another object of the present invention is to deliver a system comprising a blend of at least two hydrophobically modified polymers in a solution or suspension form so that they can be incorporated into the coating formulation in an easy way and their full benefit can be exploited. The polymers can be delivered as an aqueous solution. If the viscosity of the aqueous solution is too high (>3000 cps), the viscosity of the aqueous solution can be attenuated by adding viscosity suppressing agents. Examples of viscosity suppressing agents for hydrophobically modified polymers are cyclodextrins and their derivatives, surfactants and water-miscible organic solvents. Alternatively, an aqueous suspension of particulate polymers of the present invention with low viscosity can also be delivered using a salt that can be the salt of an organic or inorganic acid.

### DETAILED DESCRIPTION OF THE INVENTION

In the present invention, water-soluble polymers that are further modified with hydrophobes can be synthetic, natural polymers and modified natural polymers or semisynthetic polymers. They can be: nonionic, anionic, cationic and amphoteric.

The present invention is directed to covalently attaching more than one type of hydrophobe onto various water-soluble polymers. Preferably, the hydrophobes are grafted onto the water-soluble polymer backbone as pendant groups and they are placed as far apart as possible and more preferably, the hydrophobes are grafted at the chain termini. Depending on the structure of the water-soluble polymer and the location of the reactive sites on the polymer, the hydrophobes can be grafted onto the main backbone as pendant groups or at the

[symbol]

In the present invention, the term “mixed hydrophobe modified polymers” means polymers modified with multiple types of hydrophobes. For preformed water-soluble polymers, the number of various types of hydrophobes that can be grafted onto them is limited by the nature and number of the functional groups available on them. For making mixed hydrophobe modified polymers by connecting appropriate monomer units comprised of hydrophilic and hydrophobic units, the molar ratio of hydrophilic to hydrophobic units can be tailored. If the monomers contain polymerizable groups, such as vinyl group, they can be covalently connected by free radical polymerization process. Preparation of water-soluble polymers from vinyl monomers using a free radical process is known in the art.

The term “hydrophobe” means all reagent residues that are chemically bonded to the polymer and contribute to the hydrophobicity of the polymer. The hydrophobes may belong to various chemical families selected from but are not limited to hydrocarbyl, fluorocarbyl and organosiylyl. In general, hydrocarbyl hydrophobes are differentiated based on the number of carbon atoms present in them. However, for hydrocarbyl groups having the same number of carbon atoms, they are also differentiated based on their: (a) degrees of unsaturation (carbon-carbon multiple bond), (b) spatial arrangements of the carbon atoms and (c) the presence of other non-carbon functional groups. In general, the hydrophobicity of straight chain alkyl groups increases as the number of carbon atoms increases. However, the hydrophobicity of hydrophobes having a fixed number of carbon atoms and connected by chemical bonds would depend on other factors. These include, (a) spatial arrangement of the carbon atoms, i.e., whether they are connected to form linear, branched, and cyclic structure, (b) the presence of unsaturation, and (c) the presence of substituents on them. Since they will have different hydrophobicity, they would be considered distinct. For example, a linear hexyl (C₆H₁₃—) group is different from a cyclohexyl (C₆H₁₁—) group or a hexynyl (C₆H₁₁—) group or a hydroxyhexyl (C₆H₁₂(OH)—) group although they all contain the same number of carbon atoms. Similarly, for [symbol] red different.

In the present invention, the term “hydrophobe” means not only the discrete hydrocarbyl or fluorocarbyl or organosiylyl residue derived from hydrophobic reagents but also the “composite hydrophobe” derived from the combination of the hydrophobe reagent residue and the adjacent group that is hydrophobic. An example of a “composite hydrophobe” is R1-X-R2, where R1 and R2 are two different hydrophobic moieties connected by a functional group (X), such as ether, ester, urethane and amide. R2 can be monofunctional or difunctional. For example, in (CH₂)ₙ—O—C₁₆H₃₃, the terminal hexadecyl group (C₁₆H₃₃) is connected to the polymethylene unit, —(CH₂)ₙ—, by an ether linkage and the “composite hydrophobe” has n+16 carbon atoms, whereas in (CH₂)ₙ—NHCO₂—C₁₆H₃₃, the terminal hexadecyl group (C₁₆H₃₃) is connected to the polymethylene unit, —(CH₂)ₙ—, by a urethane linkage and the “composite hydrophobe” has n+17 carbon atoms. If the two hydrophobes, R1 and R2, are separated by a long hydrophilic segment, they are considered discrete hydrophobes. For example, the polymethylene unit, —(CH₂)ₙ— and the C₁₆H₃₃ group in —(CH₂)ₙ—O(CH₂CH₂O)ₘ—C₁₆H₃₃ are separated by a hydrophilic polyethylene oxide chain and in this case, they would be considered two discrete hydrophobes. Since epoxylated or glycidated hydrophobic reagents could undergo oligomerization during their reaction with water-soluble polymers bearing active hydrogens, the resulting hydrophobe derived from epoxylated hydrophobic reagents could be an oligomeric species. For example, an alkyl glycidyl ether could react with the polymer to form a hydrophobe that would be a “composite hydrophobe” comprising multiple alkyl glycidyl ether units connected by ether linkages. In this situation, a mono alkyl glycidyl ether hydrophobe residue would be considered different from the poly(alkyl glycidyl ether) hydrophobe residue derived from the oligomerization of the alkyl glycidyl ether.

In the present invention, various types of hydrophobes can be incorporated into a preformed water-soluble polymer by the reaction of the water-

[symbol]

The mixed hydrophobe modified polymers can also be made by copolymerizing a mixture of ethylenically unsaturated polymerizable monomers in a free radical process, wherein the desired hydrophobic comonomers of different types can be appropriately included during the polymerization process to incorporate the hydrophobes into the polymer backbone.

In a preferred embodiment of the present invention, a water-soluble polymer bearing groups capable of reacting with the desired hydrophobic reagents is used to prepare the mixed hydrophobe modified polymers of the present invention. Examples of such water-soluble, polymers include but not limited to are poly(alkylene oxide) based nonionic synthetic water soluble polymers, poly(alkylene oxide) based nonionic synthetic water soluble polymers bearing urethane linkages, poly(alkylene oxide) based nonionic synthetic water soluble polymers bearing aminoplast-ether linkages, polyacrylate based water-soluble polymers, unmodified and modified polysaccharides, polyacrylamides, copolymers of acrylamides and other polymerizable monomers, fully and partially hydrolyzed polyvinyl acetates, copolymers of vinyl alcohol and vinyl monomers, polyamines, copolymers of vinyl alcohol and vinyl amine, poly(alkyl-oxazolines), and copolymers of alkylene oxides and vinyl monomers.

In the present invention, nonurethane HM-NSPs are those that do not carry any urethane linkage in their main backbone. They, however, carry hydrophobes at their chain ends and/or bear pendant hydrophobes connected by urethane linkages.

The desired hydrophobes can be incorporated into the chain ends of synthetic water-soluble polymers according to the teachings of U.S. Pats. relating to making hydrophobically modified nonionic synthetic polymers (HM-NSPs) described in and incorporated by reference in the Background of the Invention. However, depending on the nature and reactivity of the hydrophobic reagents, appropriate reaction conditions need to be used. The water-soluble polymer can be a preformed high molecular weight polymer with a weight average molecular weight (M_{w}) from about 500-150,000 Daltons, preferably with an M_{w} of from about 5,000 to 130,000 Daltons and most preferably with an M_{w} of from about 4,000 to 100,000 Daltons.

Alternatively, the water-soluble polymer precursor can be made by copolymerizing low molecular weight nonionic synthetic water-soluble polymer with a polyfunctional reagent capable of selectively reacting with the chain ends of the water-soluble polymer. The molecular weight of the polymer can be tailored by varying the molar ratio of the starting water-soluble polymer to the polyfunctional reagent. The polyfunctional reagent can have anywhere between 2 and 6 reactive groups, preferably 3 to 4 groups and most preferably 2 groups to form a linear polymer. Examples of polyfunctional reagents include but not limited to polyhalogenated reagents, polyepoxides, polyisocyanates, aminoplasts and polyvinyls. Linking groups arising from the reaction of the polyfunctional reagents with the water-soluble polymer blocks include but are not limited to acetals, ketals, ethers, aminoplast-ethers, amides, urethanes, ureas, and esters. Polyfunctional reagents with vinyl groups can react with water-soluble polymers bearing active hydrogens to form appropriate linkages. For example water-soluble polymers with OH, —SH, and —NH can form ether, thioether and N-alkylated derivatives respectively.

Polyhalogenated reagents to make water-soluble copolymers with acetal or ketal linkages are disclosed in U.S. Pat. Nos. 5,574,127 and 6,162,877. Preferred polyhalogenated reagents are alpha,omega-dihalogenoalkanes and gem-dihalogeno reagents having 1 to 20 carbon atoms. In addition to halogens, the gem-dihalogeno reagents may contain other groups, such as alkyl, hydroxyl, vinyl, hydroxyalkyl, alkylamine, attached to the carbon atom bearing gem-

[symbol]

To prepare mixed hydrophobe modified polymers with hydrophobes at chain ends, the starting water-soluble polymer can be any synthetic water-soluble polymer or mixtures of water-soluble or water-swellable polymers bearing reactable groups at the chain termini. Preferred reactable groups present on the water-soluble polymer include, but are not limited to —OH, —N—H, —S—H, —CH═CH₂, —N═C═O, ═CO—X, —CO₂R, where X= a halogen atom and R=an alkyl group. Examples of such polymers include homopolymers and copolymers of alkylene oxides, poly(2-ethyl-2-oxazoline), polyacrylates, etc. Derivatives of polyalkylene glycols terminated with —OH groups, —S—H groups, N—H bonds, —COOH, —COCl, —C═O, —CHO, —CH═CH₂, —COOR (where R=alkyl group) can be used in the present invention, the preferred ones being polyalkylene glycols, also referred to as poly(alkylene oxides) and the most preferred ones being polyethylene glycols. The molecular weight of the starting polyalkylene glycols can range from 200-40,000, preferably from 1,000-30,000 and most preferably from 5,000-20,000. The starting water-soluble polymer can already have a hydrophobe at one end of the polymer chain. A mixture of water-soluble polymers having reactable groups at both ends or at one can be used. The preferred one is being the polymer with hydrophobes at one chain end. Polymers of this type can have the general structure:

R-(AO)ₘ—(BO)ₙ—H

where R=hydrophobe with at least one carbon atom,
AO=ethylene oxide,
BO=propylene oxide and butylene oxide.
m=2-1000, and
n=2-100

Mixed hydrophobe modified polymers having two different types of hydrophobes at chain ends can be made by hydrosilation of water-soluble polymers bearing —CH═CH₂ groups at their chain ends with multiple type of hydrophobic reagents having Si—H bonds as shown below.

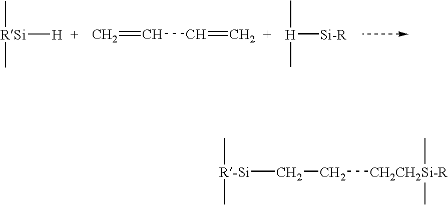

where [symbol] a water-soluble polymer,
R and R′ are two different hydrophobes

To bring about hydrosilation, a catalyst is required. Several hydrosilation catalysts are known in the art and one such catalyst is chloroplatinic acid, H₂PtCl₆.

The structures of the water-soluble polymers of use in the present invention can be linear, comb, star, branched, and highly branched (dendrimers). The polymers may contain cationic, anionic or zwitterionic functionality. The preferred ones are substantially free of charges and the most preferred ones are devoid of charges.

The nonionic polymers of use in the present invention contain different hydrophobes at different parts of the polymer backbone. Preferably, the polymer chain ends carry different hydrophobes. Chemically different hydrophobes can also be pendant from the polymer backbone.

Pendant hydrophobes of different types can be incorporated into the polymer backbone by copolymerizing a mixture of polyfunctional reagent, a polyalkylene oxide, and compound(s) bearing alpha,omega-active hydrogen atoms and their alkoxylated derivatives as disclosed in U.S. Pat. No. 6,162,877. The pendant hydrophobe can be placed randomly or alternately on the polymer backbone.

In the present invention, urethane-linkage-bearing HM-NSPs are those that carry at least one urethane linkage in their backbone or at least one chain

[symbol]

a.) at least one water-soluble polyether containing one or more active hydrogens or isocyanato groups,

b.) at least two different monofunctional hydrophobic compound capable of reacting with the active hydrogens or the isocyanato group of the water-soluble polyether in (a),

c.) at least one organic polyisocyanate

The urethane-linkage-bearing HM-NSPs may optionally contain units or residues derived from reactants (c) as shown above.

Depending on the process conditions used to prepare the mixed hydrophobe polymers of use in the present invention, the polymer compositions of use in the present invention can also have polymeric species having identical hydrophobe at chain termini in addition to polymers bearing different hydrophobes. The relative abundance of polymers having identical hydrophobes and different hydrophobes at chain ends would depend on the number and relative amount of each of the hydrophobic reagents and the starting polymer used in the process to prepare the mixed hydrophobe modified polymers.

Hydrophobically modified alkali-soluble or —swellable polyacrylates (HM-APAs) containing one type of hydrophobe are made by free radical polymerization of a mixture of ethylenically unsaturated monomers and a hydrophobic comonomer bearing a polymerizable group. The hydrophobic comonomer may or may not contain a spacer, typically an alkylene oxide oligomer, between the hydrophobe and the polymerizable group. The spacer can be connected to the polymerizable moiety by ether, acetal, urethane, ester or amide linkages. To prepare HM-APAs bearing mixed hydrophobes, a mixture of

[symbol]

Preparation of hydrophobically modified polyacrylamides are disclosed in U.S. Pat. Nos. 4,425,469, 4,432,881, 4,463,151, 4,463,152 and 4,772,962, the disclosures of which are incorporated herein by reference in their entireties. Mixed hydrophobe modified polyacrylamides of use in the present invention can be made according to these methods using a mixture of hydrophobic acrylamide and or hydrophobic acrylate comonomers.

Mixed hydrophobe modified cellulose ethers can be made according to U.S. Pat. No. 4,904,772 incorporated herein by reference in its entirety. Preferred cellulose ethers are those that contain at least one of the substituent types selected from the group consisting of hydroxyethyl, hydroxypropyl, carboxymethyl, methyl and ethyl radicals and reasonable number of hydroxyl groups or other groups capable of reacting with the hydrophobic reagent(s). Hydroxyalkyl cellulose ethers with hydroxyalkyl molar substitution of about 1.0 to 4.5 are preferred. To tailor the rheological properties, more than two different types of hydrophobes can be attached to the cellulose ether.

Other mixed hydrophobe modified polysaccharides of use in the present invention can be made by reacting starch, xanthan gum, carrageenans, polygalactomannans and their various derivatives with appropriate hydrophobic reagents. Examples of polygalactomannans include guar cassia gum, and locust bean gum. Examples of derivatives of these polysaccharides include those containing at least one of the substituents selected from carboxymethyl, cationic

[symbol]

The hydrophobic groups incorporated into the chain ends of the polymer or onto the polymer backbone as pendant groups contain 1 to 50 carbon atoms. They are selected from hydrocarbyl, alkyl, aryl, arylalky, cycloaliphatic, polycyclic groups, perfluroalkyl, poly(epoxyalkanes), poly(glycidyl alkanes), carbosilyls, polysilanes, poly(alkoxy)silanes, complex dendritic hydrophobes, and fullerenes. The preferred hydrophobes are those with alkyl groups having 4-30 carbon atoms, most preferred being 6-20 carbon atoms. These hydrophobic groups can be saturated unsaturated, branched or linear. If the hydrocarbyl hydrophobes belong to the same homologous series, the difference in the number of carbon atoms among the different types of hydrophobes should be at least two and the upper limit should be 8. If the hydrophobes do not belong to a homologous series and/or are chemically different, this restriction does not apply. Thus, —C₄H₉ group is different from —C₄H₉ and Si(CH₃)₂—CH₂CH₃, albeit they contain the same number of carbon atoms. Therefore, polymers modified with —C₄H₉ group and —C₄F₉ would be considered mixed hydrophobe modified polymers.

When the hydrophobes are independently selected from alkyl, perfluoroalkyl, and carbosilyl and oligomeric epoxyalkanes, the number of carbon atoms in the hydrophobic moiety is 1 to 50. When the hydrophobes are based on aryl, arylalkyl, cycloaliphatic, polycyclic compounds and poly(epoxy alkane), poly (epoxy arylalkyl), the carbon range is from 3-50 with the preferred range being from 6 to 30 carbons and most preferred range being 10 to 25 carbon atoms.

The hydrophobes are chemically bonded to the polymer chain ends or the polymer backbone by ether, thioether, acetal, ketal, urethane, urea, aminoplast-ether, amide and ester linkages. The hydrophobes can be linear, branched, dendrimers or oligomers. The hydrophobes can have additional chemical groups such as —OH, ≡Si—OH, —COOH, —SO₃⁻Na⁺, phosphates, and cationic groups at the tip of the hydrophobes. For hydrocarbyl- or fluorocarbyl-based hydrophobes, instead of being a contiguous connection of carbon atoms,

[symbol]

A wide variety of mixed hydrophobe modified polymers made by reacting synthetic water-soluble polymer with a wide variety of hydrophobic reagents, can be used in a system comprising at least two hydrophobically modified polymers where in one of the hydrophobically modified polymers is modified with more than one type of hydrophobe. The number and type of hydrophobes incorporated into the polymer can be adjusted by the choice of various hydrophobic reagents, their amounts and the process conditions. Incorporation of each hydrophobe type can be done either sequentially or simultaneously depending on the nature of the hydrophobic reagent. If the hydrophobic reagents belong to the same class, they can be reacted simultaneously with the water-soluble polymer. If the hydrophobic reagents belong to different classes, have different reactivities and require different reaction conditions for grafting onto the water-soluble polymer, they can be incorporated in multiple stages using appropriate reaction conditions. For example, for polymers bearing hydrophobes at chain ends, one hydrophobe could be attached to the polymer chain end by a urethane linkage and the other hydrophobe could be connected to the other end of the chain through an acetal, ether, ester or amide linkage by selecting appropriate reaction conditions.

The process of the present invention permits tailoring of the rheology of aqueous or water-borne coating compositions. This process comprises obtaining an amount of a first hydrophobically modified polymer comprising a polymer backbone modified with a first hydrophobe and an amount of a second hydrophobically modified polymer comprising the first hydrophobically modified polymer further modified with a second hydrophobe. The first hydrophobically modified polymer may be either a water-soluble, water-dispersible or water-swellable polymer. The first hydrophobe and the second hydrophobe are different from each other. This permits a formulator of aqueous or water-borne coating compositions to select an amount of the first hydrophobically modified polymer relative to the amount of the second hydrophobically modified polymer to tailor the rheology of the aqueous or water-borne coating composition.

Since the first hydrophobically modified polymer and the second hydrophobically modified polymer share a common polymeric backbone and at least one hydrophobe, they are relatively compatible with one another. For example, the second hydrophobically modified polymer may be characterized by its first and second hydrophobes having in the range of 1 to 40 carbon atoms and wherein the first hydrophobe has at least two carbon atoms more than the second hydrophobe. Alternatively for example, the second hydrophobically modified polymer may be characterized by its first and second hydrophobes having in the range of 1 to 40 carbon atoms and wherein the first hydrophobe has at least two carbon atoms less than the second hydrophobe. By utilizing different hydrophobes on polymers sharing a common polymeric backbone and like hydrophobes, the hydrophobically modified polymers should belong to the same chemical class of polymers, can be delivered in the same physical form (e.g., powder, solution or dispersion), and should be chemically compatible with one another.

The amount of the first hydrophobically modified polymer of utility in the present invention is from 0.05 to 10 wt %, preferably from about 0.01 to 5 wt %, more preferably from about 0.5 to 2 wt % of the aqueous or water-borne coating composition and the amount of a second hydrophobically modified polymer is from about 0.01 to 8 wt %, preferably from about 0.01 to 5 wt %, more preferably from 0.01 to 3 wt % of the aqueous or water-borne coating composition.

The polymer backbone of the first hydrophobically modified polymer and the second hydrophobically modified polymer may be selected from the group consisting of synthetic polymers, polyacrylates, polyacrylamides, polysaccharides and derivatives thereof.

The polymer backbone of the synthetic polymers may be selected from the group consisting of non-urethane polyether polymers and urethane-bearing polyether polymers. In one embodiment, the second hydrophobically modified polymer comprises a urethane or a non-urethane polyether polymer further comprising: polyether segments connected by ether, acetal, ketal ester,

[symbol]

A preferred lower limit of the weight average molecular weight of the urethane and non-urethane polyether polymer of use in the process of the present invention is about 4000 Daltons, preferably about 8000 Daltons and more preferably about 20,000 Daltons.

One advantage of the process of the present invention is that the mixed hydrophobe modified polymers exhibit a combination of rheological properties of particular interest to coating formulators. Through the selection of an amount of the first hydrophobically modified polymer relative to the amount of the second hydrophobically modified polymer, in combination with an aqueous or water-borne coating composition results in aqueous or water-borne coatings having a Brookfield viscosities in the range of 1000-7000 cps at 5 sec⁻ or Stormer viscosities in the range of 80-130 KU and high-shear viscosity (ICI viscosity) in the range of 0.1-3.8 poise at 10,000 sec⁻¹. The viscosities are all measured at 25° C. This combination of viscosities is of particular interest to coating formulators concerned with challenges regarding both the application as well as the aesthetics of aqueous or water-borne coatings.

Depending on the compositions, mixed hydrophobe modified polymers of use in the process of the present invention exhibit very high solution viscosity (>1000 cps) in water at polymer concentrations greater than 2 wt %. Hence, under ambient temperatures, transfer of high solids (>5 wt %) solutions of these polymers from one container to another is extremely difficult. In addition, highly viscous solutions tend to remain separated when added to various highly-filled aqueous formulations, such as water-borne coatings.

To overcome the above problem is another aspect of the present invention comprises adding to aqueous or water-borne coating composition an amount of a viscosity suppressing agent selected from the group consisting of cyclodextrins and their derivatives, surfactants and water-miscible organic solvents.

In one embodiment, the solution viscosity of mixed hydrophobe modified polymers is suppressed by adding an effective amount of viscosity suppressing agent comprising a cyclodextrin compound capable of complexing inside its hydrophobic cavity with the hydrophobe(s) of the mixed hydrophobe modified polymers in an aqueous environment. Various cyclodextrins that can be used to suppress the solution viscosity of hydrophobically modified poly(acetal- or ketal-polyethers) are disclosed in U.S. Pat. No. 6,809,132, the disclosure of which is incorporated herein by reference in its entirety. These cyclodextrins of different cavity sizes and their derivatives can be employed to suppress the solution viscosity of mixed hydrophobe modified polymers of use in the present invention wherein the cyclodextrin is selected from the group consisting of alpha, beta, and gamma cyclodextrin. The cyclodextrin of use in the present invention may be selected from the group consisting of methylated, hydroxyethylated, hydroxypropylated, carboxymethylated, and diaminoethylated cyclodextrins and mixtures thereof. Preferred cyclodextrins are beta-cyclodextrin and its derivatives and most preferred ones are nonionic beta-cyclodextrin derivatives having water-solubility greater than 3 grams per 100 g of water.

The amount of cyclodextrin of use in the compositions of the present invention is from about 0.1-10% by weight of the composition, preferably about 0.5-7% by weight of the composition and most preferably about 1-5% by weight of the composition.

For thickening aqueous systems using cyclodextrin-containing hydrophobically modified water-soluble polymer solutions, it is critical to reversibly break the association between the cyclodextrin cavity and the hydrophobe. This can be done by adding a surface-active agent that can compete with the hydrophobe of the polymer to bind with the cyclodextrin cavity. Various nonionic,

[symbol]

An alternative approach to bring about the inter-chain hydrophobic association of the hydrophobically modified water-soluble polymer would be to destroy the cyclic structure of the cyclodextrin by adding a cyclodextrin hydrolyzing enzyme, also known as cyclodextrin hydrolase. Depending on the composition of the cyclodextrin, the cyclodextrin hydrolases would hydrolyze the glycosidic linkages of the anhydroglucose units of cyclodextrin to form an open linear structure of anhydroglucose units and/or depolymerized sugar species.

In another embodiment, the composition to reduce solution viscosity of mixed hydrophobe modified polymers comprises: (a) mixed hydrophobe modified polymers and (b) a surface-active agent. Aqueous dispersions of hydrophobically modified polyacetal- or ketal-polyethers) made using surface-active agents are disclosed in U.S. Pat. No. 7,531,591, the disclosure of which is incorporated herein by reference in its entirety. These groups of surface-active agents can be used to suppress the viscosity of high solids solutions of mixed hydrophobe modified polymers of the present invention.

In accordance with the present invention, typical viscosity reducing agents also may be selected from the group consisting of anionic, cationic, non-ionic zwitterionic, and Gemini surfactants. Nonionic surfactants include alcohol ethoxylates (C₁₀-(EO)₆ —Iconol DA-6 (EO=ethylene oxide unit), Ethal DA-6 and Huntsman DA-6; C₁₀-(EO)₉—Ethal DA-9; C₉₋₁₁-(EO)₆—Rhodasurf 91-6), ethoxylated 2,4,7,9-tetramethyl-5-decyn-4,7-diol or Surfynol 465 (Air Products); C₆ alkylglucoside (AG 6206, Akzo-Nobel); C₈ alkylglucoside (AG 6202, Akzo- [symbol] ₈-C₁₀ alkylglucoside (AG 6210, Akzo-Nobel); C₁₀-alcohol ethoxylate PEG (7EO), Biodac 710 (Sasol); C₁₋₁₀-alcohol ethoxylate PEG (8EO), Biodac 810 (Sasol); Primary alcohol ethoxylate, C₉-C₁₂, PEO(6), Synperonic 91/6 (ICI); decyl glucoside, Plantacare 200 UP (Henkel). Gemini surfactant (Air Product, acetylenic diols surfactants).

The amount of anionic, cationic, non-ionic zwitterionic or Gemini surfactants may be in the range of about 2-25%, preferably about 4-20% most preferably about 7-15% by weight of the composition.

Yet in another embodiment, the composition to deliver mixed hydrophobe modified polymers containing high solids comprises: (a) mixed hydrophobe modified polymers and (b) carbon-containing electrolytes. Aqueous dispersions of the mixed hydrophobe modified polymers of the present invention could be made by suspending the finely divided particles of mixed hydrophobe modified polymers in an aqueous environment enriched with carbon-containing electrolytes. Delivery of aqueous dispersions of hydrophobically modified poly(acetal- or ketal-polyethers) using carbon-containing electrolytes is disclosed in U.S. Pat. Nos. 6,369,132 and 6,433,056. These documents are incorporated herein by reference in their entireties.

Examples of aqueous systems where process of the present invention can be used are latex paints, water-borne alkyd paints, building materials, personal care products, such as shampoos, hair conditioners, hand lotions, toothpastes, antiperspirants, etc., water-borne inks and adhesives, drilling muds for oilwell drilling, ceramic adhesives and binders, liquid detergents as cleansers, fabric softeners, pesticides and agricultural compositions, paper, paper board and paper coating formulations, pharmaceuticals, deicing aircrafts, and fire-fighting fluids.

Thickeners are also referred to as rheology modifiers as they modify the rheology of coatings. Although thickeners are minor components of a coating formulation, they are very critical to formulate water-borne coatings as they control or significantly affect many rheological properties. Organic as well as

[symbol]

One of the rheological properties measured for water-borne coatings is their mid-shear viscosity, commonly referred to as Stormer viscosity. The Stormer viscosity of a coating reflects its ability to resist pigment settlement on storage and provide good brush loading during applications. It is measured by a Stormer viscometer by measuring the time taken for an inner cylinder in the viscometer to perform 200 revolutions per minute in response to an actuating weight and expressed in Krebs units (KU) (ASTM D662-81).

For typical water-borne coatings, the Stormer viscosity ranges from 90 to 120 KU. The amount of thickener(s) on a dry basis needed to achieve the target Stormer viscosity of coatings is called thickening efficiency (TE) or thickener demand. TE is expressed as weight fraction of the dry thickener with respect to the total weight of the wet coating. Coatings formulators, however, prefer to express TE as pounds of dry thickener required per 100 gallon of wet coatings. Coating formulators incorporate thickeners into the coating formulation to achieve a target Stormer viscosity. For economic reasons, polymers that provide efficient buildup of Stormer viscosity are desirable.

The Stormer viscosity buildup (or TE) depends on the pigment volume concentration (PVC) of coatings and various ingredients used in the formulation. PVC (%) is defined as shown below.

$$P V C ( \% ) = \frac{Volume of pigment ( s )}{Volume of pigment ( s ) + Volume of binder ( s )} \times 100$$

PVC is a measure of how binder-rich a given coating formulation is.

Pigments used in coatings could be both prime pigment (primary coloring agent for the coating) as well as extender pigments (fillers used to lower coatings' costs or improve other properties). Titanium dioxide is the prime pigment extensively used in formulating coatings. Extender pigments include clay, silica, talc, calcium carbonate, calcium sulfate and zinc oxide.

Another formulating parameter used in coatings industry is the volume solids (VS) content that is defined as shown below.

$$V S ( \% ) = \frac{\begin{matrix}Dry volume of pigment ( s ) + \\ Dry volume of extender pigment ( s ) + \\ Dry volume of binders\end{matrix}}{Total volume of the wet coating forumlation} \times 100$$

If other additives are used, their volumes are not included to calculate the total dry volume.

Another desired rheological property for water-borne coatings is to have good “brush drag” or good “film build” during applications on the substrate. Good “film build” means the formation of a continuous film to cover surface of the substrate that is being coated with a brush or roller. Typically, the film building ability of a coating is measured by measuring the viscosity of the coating at a shear rate of 10,000-14,000 sec⁻¹, referred to as ICI viscosity. It is measured using a cone and plate viscometer and expressed in poise or mPa·s (1 poise=100 mPa·s). The ICI viscosity of most commercial coatings ranges between 0.8 and 3.5 poise. For premium quality gloss paints, higher ICI viscosity (>1.5 poise) is desirable.

For water-borne coatings, the mixed hydrophobe modified polymers of the present invention also provide other rheological properties, such as flow, spatter resistance, suspension of dispersed species over a shear rate of 0.01 sec⁻¹ to 14,000 sec⁻¹.

In accordance with the present invention, the system comprising at least two hydrophobically modified polymers of the present invention can be used in water-borne coating compositions; the pigment volume concentration (PVC) of the coatings can have a lower limit of 5, preferably 10 and an upper limit of 85, preferably 80. More particularly, when the water-borne coating composition is a high gloss coating, the PVC is from about 15 to about 30; when the coating is a semigloss coating, the PVC is from about 20 to about 35; and when it is a flat, satin or egg-shell coating, the PVC is from about 35 to about 80. Also for water-borne coatings, the low-shear viscosity, measured at 5 to 12 sec⁻¹ at 25° C. using a Stormer viscometer, should be 60-120 Kreb units (KU), preferably about 100 KU and high-shear viscosity or the ICI viscosity should be between 0.8 and 3.5 poise measured at 10,000 sec⁻¹ at 25° C.

The system comprising at least two hydrophobically modified polymers of the present invention may be used in combination with other thickeners. Examples of such thickeners are traditional thickeners bearing no hydrophobes and hydrophobically modified thickeners bearing other types of hydrophobes.

The scope of the present invention as claimed is not intended to be limited by the following examples, which are given merely for the purpose of illustration. The following examples will serve to illustrate the invention, parts and percentages being by weight unless otherwise indicated.

### Example 1

### Preparation of C₁₂/C₁₆ Mixed Hydrophobe Modified poly(acetal-polyether)

To a Hockmeyer mixer were charged polyethylene glycol (molecular weight ˜9000; PEG-9000) (2700 g) and sodium hydroxide (76 g). After sealing

[symbol]

The C₁₂/C₁₆ modified poly(acetal-polyether) thus made was soluble in water. The 20% solution viscosity of this polymer was 9600 cps at 30 rpm at 25° C. The weight average molecular weight (M_{w}) of the copolymer was 38,700 and the polydispersity index was 1.78.

### EXAMPLES 2-8

A series of C₁₂/C₁₆ modified poly(acetal-polyethers) were made according to Example 1 by varying the relative amounts of 1-bromododecane C₁₂H₂₅Br) and 1-bromohexadecane (C₁₆H₃₃Br).

The results are shown below.

| | C₁₂H₂₅Br | C₁₆H₃₃Br | M_{w} | 20% solution BF |
|---|---|---|---|---|
| Example No. | (g) | (g) | Daltons) | viscosity (cps) |
| 2 | 115 | 12 | 38,100 | 6750 |
| 3 | 109 | 18.3 | 37,100 | 7560 |
| 4 | 108 | 28 | 36,400 | 10170 |
| 5 | 97 | 35 | 38,100 | 12000 |
| 6 | 78.6 | 64.2 | 34,000 | >20,000 |
| 7 | 65 | 85 | 35,100 | >20,000 |
| 8 | 52.4 | 96 | 35,200 | >20,000 |

### EXAMPLES 9-11

### Preparation of C₆/C₁₆ Modified Poly(Acetal-Polyethers)

A series of C₆/C₁₆ modified poly(acetal-polyethers) were made according to Example 1 by varying the relative amounts of 1-bromohexane C₆H₁₃Br) and 1-hexadecane (C₁₆H₃₃Br).

The results are shown below.

| | C₆H₁₃Br | C₁₆H₃₃Br | M_{w} | 20% solution BF |
|---|---|---|---|---|
| Example No. | (g) | (g) | (Daltons) | viscosity (cps) |
| 9 | 48 | 116 | 33,900 | >20,000 |
| 10 | 43 | 85 | 38,400 | >20,000 |
| 11 | 62 | 50 | 37,300 | 3630 |

### EXAMPLES 12-16

### Preparation of C₁₂/C₁₄ Modified Poly(Acetal-Polyethers)

A series of C₁₂/C₁₄ modified poly(acetal-polyethers) were made according to Example 1 by varying the relative amounts of 1-bromododecane (C₁₂H₂₅Br) and 1-bromotetradecane (C₁₄H₂₉Br).

The results are shown below.

| | C₁₂H₂₅Br | C₁₄H₂₉Br | M_{w} | 20% solution BF |
|---|---|---|---|---|
| Example No. | (g) | (g) | (Daltons) | viscosity (cps) |
| 12 | 115 | 19.5 | 38,200 | 6630 |
| 13 | 108 | 25.5 | 36,100 | 6700 |
| 14 | 102 | 36 | 36,600 | 7800 |
| 15 | 95 | 18 | 38,400 | 6000 |
| 16 | 95 | 40 | 37,100 | 10700 |

### Example 17

### Preparation of C₁₂/C₁₈ Modified Poly(Acetal-Polyethers) Using Polyethylene Glycol of Molecular Weight ˜8500

A C₁₂/C₁₈ modified poly(acetal-polyethers) was made according to Example 1 using 1-bromododecane C₁₂H₂₅Br) and 1-bromooctadecane (C₁₈H₃₇Br).

The results are shown below.

| | | | | 17.5% solution BF |
|---|---|---|---|---|
| | C₁₂H₂₅Br | C₁₈H₃₇Br | M_{w} | viscosity with 10% |
| Example No. | (g) | (g) | (Daltons) | Genapol ID-60 (cps) |
| 17 | 65 | 87 | 35,000 | 2920 |

### Example 18

### Preparation of C₁₆/C₁₈ Modified Poly(Acetal-Polyethers) Using Polyethylene Glycol of Molecular Weight ˜10,500

Example 17 was repeated using the following reagents.

1) Polyethylene glycol (molecular weight ˜10,500)—600 g
2) Sodium hydroxide—18.5 g

### 3) Dibromomethane—5 g

### 4) 1-Bromohexadecane—20.5 g

### 5) 1-Bromooctadecane—22.4 g

The weight average molecular weight of the C₁₆/C₁₈ modified poly(acetal-polyether) was 25,100. The 17 wt % solution of the polymer in conjunction with 10 wt % of Genapol® ID-60 surfactant (ethoxylated isodecyl alcohol containing 6 moles of ethylene oxide; available from Clariant Corporation), was 2300 cps at 30 rpm at 25° C.

### Solution Viscosity Suppression of High Solids Solutions of Mixed Hydrophobe Modified Poly(Acetal-Polyethers) Using Cyclodextrins

Depending on the type and amount of hydrophobes grafted onto the poly(acetal-polyethers), the high solids solutions (>2%) of the mixed hydrophobe modified poly(acetal-polyethers) would be very viscous making them difficult to transfer or incorporate into the desired aqueous formulations.

The viscosity of high solids solutions of mixed hydrophobe modified poly(acetal-polyethers) can be lowered by adding appropriate cyclodextrin(s) as disclosed in U.S. Pat. Nos. 6,809,132 and 6,900,255 as shown below. A few examples are given below.

| | C₁₂/C₁₄- | | Cyclodextrin | BF Viscosity of |
|---|---|---|---|---|
| Polymer | PAPE (g) | Water (g) | added | the solution (cps) |
| C12/C14-PAPE | 20 | 80 | None | 7470 |
| ″ | 20 | 80 | β-CD (1.5 g) | 1300 |
| ″ | 20 | 80 | HP-β-CD (1.5 g) | 1140 |
| ″ | 20 | 80 | Me-β-CD (1 g) | 1170 |

β-CD = Beta-cyclodextrin; HP-β-CD = Hydroxypropylated beta-cyclodextrin; and Me-β-CD = Methylated beta-cyclodextrin

### Solution Viscosity Suppression of High Solids Solutions of Mixed Hydrophobe Modified Poly(Acetal-Polyethers) Using Surfactants.

Various C₁₂/C₁₆ modified poly(acetal-polyethers) were dissolved in the presence of Genapol® ID-60 surfactant (ethoxylated isodecyl alcohol containing 6 moles of ethylene oxide; available from Clariant Corporation). As can be seen, by adding Genapol® ID-60 surfactant, the solution viscosity of the C₁₂/C₁₆ modified poly(acetal-polyethers) (C₁₂/C₁₆-PAPE) can be significantly lowered.

| | C₁₂:C₁₆ | | Genapol ® | | BF viscosity of |
|---|---|---|---|---|---|
| Example | mole | C₁₂/C₁₆- | ID-60 | Water | the solution |
| No. | ratio | PAPE (g) | surfactant (g) | (g) | (cps) |
| A | 85:15 | 35 | 0 | 145 | 6900 |
| B | 85:15 | 35 | 16 | 149 | 3760 |
| C | 70:30 | 35 | 0 | 145 | 12,600 |
| D | 70:30 | 35 | 20 | 145 | 2772 |
| E | 60:40 | 35 | 0 | 145 | >20,000 |
| F | 60:40 | 35 | 20 | 145 | 2868 |
| G | 50:50 | 35 | 0 | 145 | >20,000 |
| H | 50:50 | 35 | 20 | 145 | 2852 |
| I | 85:15 | 14.5 | 6.5 | 79 | 1832 |

Evaluation of Paint Properties of Modified Poly(Acetal-Polyethers) Modified with Dodecyl (C₁₂H₂₅) and Tetradecyl (C₁₄H₂₉) Hydrophobes

Several C₁₂/C₁₄ modified and C₁₂/C₁₆ modified poly(acetal-polyethers) (PAPEs) were evaluated in all-acrylic semigloss white paint containing an acrylic emulsion (Rhoplex™ SG-30 emulsion available from Rohm and Haas Company) (pigment volume concentration=25%; volatile organic compound content=150 g/liter). The details of this paint formula are given in Table A.

TABLE A
Rhoplex ™ SG-30 acrylic emulsion in an all-acrylic semigloss white paint formula

| | | | Parts |
|---|---|---|---|
| Ingredient | Chemical description | Supplier | by weight |
| Water | | | 105.24 |
| Tamol 731A | Sodium salt of a maleic | Rohm & Haas Company | 8 |
| | anhydriddee copolymer | | |
| PROXEL GXL | Mixture of 1,2-benzisothiazolin-3-one | Arch Chemical, Inc. | 3 |
| | (BIT), sodium hydroxide, and | | |
| | dipropylene glycol | | |
| AMP-95 | 2-Amino-2-methyl-1-propanol | Angus Chemical Company | 1 |
| Strodex PK-90 | Potassium salt of phosphate | Aqualon Company | 2.1 |
| | coester of alcohol and aliphatic | | |
| | ethoxylate | | |
| Triton CF-10 | 85 wt. % alkyl aryl polyether, 15 wt. % | Dow Chemical Company | 2.1 |
| | octyl phenoxy polyoxthyethanol and | | |
| | less than 3 wt. % polyethylene glycol. | | |
| Ethylene glycol | | ″ | 30 |
| Drew T-4507 | Antifoaming agent | Ashland Speciality Chemicals | 2.9 |
| TiPure R-706 | Titanium dioxide | E. I. Du Pont de Nemours and | 230 |
| | | Company | |
| Rhoplex SG-30 | Acrylic latex | Rohm & Haas Company | 438 |
| Texanol ® ester alcohol | 2,2,4-Trimethyl-1,3-pentanediol | Eastman Chemical | 12 |
| | monoisobutyrate | | |
| Water + Thickener | | | 2.9 |

The following Examples illustrate the use of C₁₂/C₁₄ and C₁₂/C₁₆ modified PAPEs to achieve a balance of low-shear (Stormer viscosity) and high-shear viscosity (ICI viscosity) in the SG-30 acrylic-based semigloss paints.

In the present case, for comparison purposes, a fixed amount of the experimental thickeners (˜1.2 wt % on a dry basis) was added to the base paint. After mixing the paint for 0.5 hour, the Stormer viscosity of the paint was measured at 25° C. This is the initial Stormer viscosity. Then the paint was left overnight. Next day, the paint was mixed again for 15 minutes and the Stormer viscosity of the paint was measured at 25° C. This is the overnight Stormer viscosity.

The results in Tables 1 and 2 show that at the same use level, C₁₂/C₁₄-PAPEs and C₁₂/C₁₆-PAPEs provide higher low-shear viscosity (Stormer viscosity) and higher high-shear viscosity (ICI viscosity) relative to those of C₁₂-PAPE (Aquaflow® NHS-300 rheology modifier available from Hercules Incorporated).

TABLE 1
Rhoplex ™ SG-30 acrylic emulsion in an acrylic
semigloss paint properties of C12/C14-PAPEs

| | | | | Rhoplex SG-30 white semigloss | | |
|---|---|---|---|---|---|---|
| | | | | base paint properties | | |
| | | | | of the HM-PAPE | | |
| | | C12 | C14 | | Stormer | ICI |
| | Mw × | (wt | (wt | TE | Viscosity | Viscosity |
| HM-PAPE | 10⁻³ | %) | %) | (wt %) | (KU) | (poise) |
| C12-PAPE | 36.7 | 1.37 | — | 1.23 | 82 | 2.8 |
| C12/C14-PAPE | 38.3 | 1.07 | 0.40 | 1.23 | 90 | 3.5 |
| C12/C14-PAPE | 36.1 | 1.54 | 0.27 | 1.23 | 89 | 3.5 |
| C12/C14-PAPE | 36.6 | 1.38 | 0.34 | 1.23 | 88 | 3.2 |
| C12/C14-PAPE | 37.1 | 1.44 | 0.42 | 1.23 | 89 | 3.3 |
| C12/C14-PAPE | 38.2 | 1.61 | 0.19 | 1.23 | 85 | 3.2 |
| C12/C14-PAPE | 37.4 | 1.49 | 0.26 | 1.23 | 87 | 3.3 |
| C12/C14-PAPE | 37.9 | 1.53 | 0.25 | 1.23 | 87 | 3.3 |
| C12/C14-PAPE | 37.6 | 1.66 | 0.26 | 1.23 | 87 | 3.2 |
| C12/C14-PAPE | 38.4 | 1.51 | 0.19 | 1.23 | 86 | 3.1 |

As can be seen from data in the above table, at the same thickener use level, C₁₂/C₁₄ modified poly(acetal polyethers) provided higher Stormer viscosity and ICI viscosity relative to those of the C₁₂ modified poly(acetal polyether).

TABLE 2
Rhoplex ™ SG-30 acrylic emulsion in an acrylic
semigloss paint properties of C12/C16-PAPEs

| | | | | Rhoplex SG-30 white semigloss | | |
|---|---|---|---|---|---|---|
| | | | | paint properties | | |
| | | | | of the HM-PAPE | | |
| | | C12 | C16 | | Stormer | ICI |
| | Mw × | (wt | (wt | TE | viscosity | viscosity |
| HM-PAPE | 10⁻³ | %) | %) | (wt %) | (KU) | (poise) |
| C12-PAPE | 36.7 | 1.37 | — | 1.23 | 82 | 2.8 |
| C12/C16-PAPE | 37.1 | 1.64 | 0.21 | 1.2 | 88 | 3.5 |
| C12/C16-PAPE | 38.1 | 1.74 | 0.15 | 1.2 | 85 | 3.2 |
| C12/C16-PAPE | 36.4 | 1.50 | 0.33 | 1.23 | 89 | 3.4 |

As can be seen from data in the above table, at the same thickener use level, C₁₂/C₁₆ modified (polyacetal polyethers) provided higher Stormer viscosity and ICI viscosity relative to those of the C₁₂ modified (polyacetal polyether).

### Example 19

### Preparation of Hexyl (C₆H₁₃) Modified Urethane-Linkage-Bearing Nonionic Synthetic Polymers

To a one-liter round-bottom flask, equipped with magnetic stirrer, condenser, nitrogen inlet and a Dean-Stark separator were added polyethylene glycol (molecular weight ˜8500; 200 g; 0.023 mol) and toluene (400 g). The resulting mixture was heated to boiling and moisture from the solution was azeotropically removed by distilling off about 60 g of toluene. Then the solution was cooled to 70° C. and dibutyltin dilaurate (0.2 g) and hexamethylene diisocyanate (8.4 g; 0.05 mol). The resulting reaction mixture was heated at 90° C. for 1 h under nitrogen atmosphere. Following this, 1-hexanol (4.5 g; 0.044 mol) was added and the resulting reaction mixture heated at 90° C. for 1 h under nitrogen atmosphere. After this, the reaction mixture was cooled to room temperature. Upon evaporation of solvent from the reaction mixture a waxy solid was isolated.

### Example 20

### Preparation of Urethane-Linkage-Bearing Nonionic Synthetic Polymers Modified with Hexy (C₆H₁₃) and Decyl (C₁₀H₂₁) Hydrophobes

Example 19 was repeated using a mixture of 1-hexanol (2.25 g; 0.022 mol) and 1-decyl alcohol (3.6 g; 0.0023 mol) in place of only 1-hexanol.

### Example 21

### Preparation of Anionic Polyacrylates Modified with Dodecyl (C₁₂H₂₅) and Tetradecyl (C₁₄H₂₉) Hydrophobes

Methacrylic acid (42.56 g), ethyl acrylate (50.56 g), LEM-23 (15.05 g; “as is”; LEM-23 is a mixture of C₁₂-(EO)ₙ-MA and C₁₄-(EO)n-MA where EO=ethylene oxide, n˜23 and MA=methacrylate residue; available from BIMAX corporation, Baltimore, Md.), sodium lauryl sulfate (3.54 g), t-dodecanethiol (98.55% pure) (0.12 g) and distilled water (10.97 g) were mixed together to form a monomer mixture solution. The mixture was shaken vigorously to form an emulsion. Then sodium lauryl sulfate (0.72 g), 2-sulfoethyl methacrylate (0.96 g), and distilled water (249.8 g) were charged to a jacketed glass reactor equipped with a mechanical stirrer, condenser and nitrogen inlet. To this mixture was

[symbol]

The monomer mixture from the syringes was added to the reactor at a feed rate of 1 ml/minute over a period of about 2 hours while the sodium persulfate solution charged to the 20-ml syringe was added to the reactor over a period of 2.5 hour at a feed rate of 0.06 ml/minute. After completing the addition of the sodium persulfate solution, the resulting polymer emulsion was reaction mixture was heated 80° C. for 1 hour. Then the reaction mixture was cooled to 40° C. and filtered with a 200-micron screen Nylon cloth.

The pH and solids content of the emulsion thus obtained were about 2.2 and 39.8 wt % respectively. The 1% solution viscosity of the emulsion at pH˜8.5 was 44 cps (measured at 30 rpm at 25° C.). The weight average molecular weight of the polymer, measured by low-angle light scattering method, was 302,000.

### Example 22

### Preparation of Anionic Polyacrylates Modified with Hexadecyl (C₁₆H₃₃) and Octadecyl (C₁₈H₃₇) Hydrophobes

The above Example was repeated using CSEM-25/85 (18 g; “as is”; available from BIMAX corporation, Baltimore, Md.). CSEM-25/85 is a [symbol] ₁₆-(EO)n-MA and C₁₈-(EO)n-MA where EO=ethylene oxide, n˜25 and MA=methacrylate residue.

The pH and solids content of the emulsion thus obtained were about 2 and 25.9 wt % respectively. The 1% solution viscosity of the emulsion at pH˜8.5 was 1530 cps (measured at 30 rpm at 25° C.). The weight average molecular weight of the polymer, measured by low-angle light scattering method, was 337,000.

While this invention has been described with respect to specific embodiments, it should be understood that these embodiments are not intended to be limiting and that many variations and modifications are possible without departing from the scope and spirit of this invention.

What is claimed is:

1. A process for tailoring rheology of an aqueous or water-borne coating composition comprising the steps of:
a) obtaining an aqueous or water-borne coating composition;
b) obtaining a system comprising
i. an amount of a first hydrophobically modified polymer comprising a polymer backbone modified with a first hydrophobe and
ii. an amount of a second hydrophobically modified polymer comprising the first hydrophobically modified polymer further modified with a second hydrophobe
wherein the first hydrophobe and the second hydrophobe are different from each other;
c) selecting the amount of the first hydrophobically modified polymer relative to the amount of the second hydrophobically modified polymer to tailor the rheology of the aqueous or water-borne coating composition; and
d) combining the aqueous or water-borne coating composition with an amount of the system to obtain an aqueous or water-borne coating composition at 25° C. with a Brookfield viscosity of between about 1000-7000 cps at 5 sec⁻¹ or Stormer viscosity of about 80-130 KU and high-shear viscosity (ICI viscosity) of about 0.1-3.8 poise at 10,000 sec⁻¹.

2. The process of claim 1 wherein the first hydrophobically modified polymer is a water-soluble, water-dispersible or water-swellable polymer.

3. The process of claim 1 wherein the second hydrophobically modified polymer is further characterized by the first and second hydrophobes having 1 to 40 carbon atoms and wherein the first hydrophobe has at least two carbon atoms more than the second hydrophobe.

4. The process of claim 1 wherein the polymer backbone of the first hydrophobically modified polymer and the second hydrophobically modified polymer are selected from the group consisting of polyacrylates, polyacrylamides, polyurethanes, non-urethane polyether polymers, polysaccharides and derivatives thereof.

5. The process of claim 4 wherein the non-urethane polyether polymers are selected from the group consisting of an aminoplast polyethers and polyacetal polyethers.

6. The process of claim 1 wherein the second hydrophobically modified polymer comprises urethanes or non-urethane polyether polymers further comprising:
a) polyether segments connected by ether, acetal, ketal ester, aminoplast and amide linkages,
b) polyether polymer chain termini are connected to two different hydrophobe types through ether, acetal, ketal, ester or amide linkages and
c) two terminal hydrophobes which differ from one another by at least two carbon atoms.

7. The process of claim 6 wherein the urethanes or non-urethane polyether polymers contains pendant hydrophobes with 1 to 40 carbon atoms in addition to terminal hydrophobes.

8. The process of claim 6 wherein the lower limit of the weight average molecular weight of the urethanes or non-urethane polyether polymers is about 500 Daltons.

9. The process of claim 8 wherein the lower limit of the weight average molecular weight of the urethanes or non-urethane polyether polymers is about 20,000 Daltons.

10. The process of claim 4 wherein the lower limit of the weight average molecular weight of the polyacrylates, polyacrylamides, polysaccharides and derivatives thereof is about 35,000 Daltons.

11. The process of claim 4 wherein the lower limit of the weight average molecular weight of the polyacrylates, polyacrylamides, polysaccharides and derivatives thereof is about 85,000 Daltons.

12. The process of claim 1 further comprising adding to aqueous or water-borne coating composition with an amount of a viscosity suppressing agent selected from the group consisting of cyclodextrins and their derivatives, surfactants and water-miscible organic solvents.

13. The process of claim 12 wherein the viscosity suppressing agent comprises a cyclodextrin.

14. The process of claim 13 wherein the viscosity suppressing agent comprises a cyclodextrin selected from the group consisting of alpha, beta, and gamma cyclodextrin.

15. The process of claim 13 wherein the cyclodextrin is selected from the group consisting of methylated, hydroxyethylated, hydroxypropylated, carboxymethylated, and diaminoethylated cyclodextrins and mixtures thereof.

16. The process of claim 13 wherein the cyclodextrin is added to the aqueous or water-borne coating composition in the range of about 0.1-10% by weight of the aqueous or water-borne coating composition.

17. The process of claim 16 wherein the cyclodextrin is added to the aqueous or water-borne coating composition in the range of about 0.5-7% by weight of the aqueous or water-borne coating composition.

18. The process of claim 16 wherein the cyclodextrin is added to the aqueous or water-borne coating composition in the range of about 1-5% by weight of the aqueous or water-borne coating composition.

19. The process of claim 12 wherein the viscosity suppressing agent comprises a surfactant selected from the group consisting of anionic, cationic, non-ionic zwitterionic and Gemini surfactants.

20. The process of claim 19 wherein the surfactant comprises about 2-25% by weight of the aqueous or water-borne coating composition.

21. The process of claim 20 wherein the surfactant comprises about 4-20% by weight of the aqueous or water-borne coating composition.

22. The process of claim 20 wherein the surfactant comprises about 7-15% by weight of the aqueous or water-borne coating composition.

23. An aqueous or water-borne coating composition comprising:
i.) a first hydrophobically modified polymer comprising a polymer backbone modified with a first hydrophobe and,
ii,) a second hydrophobically modified polymer comprising the first hydrophobically modified polymer further modified with a second hydrophobe;
a latex; and water,
wherein the aqueous or water-borne coating composition, at 25° C., has a Brookfield viscosity of between about 1000-7000 cps at 5 sec⁻¹ or Stormer viscosity of about 80-130 KU and high-shear viscosity (ICI viscosity) of about 0.1-3.8 poise at 10,000 sec⁻¹ and wherein the first hydrophobically modified polymer comprises from about 0.05 to 10 wt % of the aqueous or water-borne coating composition and the a second hydrophobically modified polymer comprises from about 0.01 to 8 wt % of the aqueous or water-borne coating composition.

24. The aqueous or water-borne coating composition of claim 23 wherein the first hydrophobically modified polymer comprises from about 0.01 to 5 wt % of the aqueous or water-borne coating composition and the a second hydrophobically modified polymer comprises from about 0.01 to 4 wt % of the aqueous or water-borne coating composition.

25. The aqueous or water-borne coating composition of claim 23 wherein the first hydrophobically modified polymer comprises from about 0.5 to 2 wt % of the aqueous or water-borne coating composition and the a second hydrophobically modified polymer comprises from about 0.05 to 1 wt % of the aqueous or water-borne coating composition.

26. The aqueous or water-borne coating composition of claim 23 further comprising a pigment.

27. The aqueous or water-borne coating composition of claim 26 wherein the pigment is selected from the group consisting of hydrated aluminum oxide, barium sulfate, calcium silicate, clay, silica, talc, titanium dioxide, zinc oxide, and mixtures thereof.

28. The aqueous or water-borne coating composition of claim 23, wherein the latex is selected from the group of 100% acrylics, vinyl-acrylics, and styrene-acrylics.

29. The aqueous or water-borne coating composition of claim 23 wherein the polymer backbone of the first hydrophobically modified polymer and the second hydrophobically modified polymer are selected from the group consisting of polyacrylates, polyacrylamides, polyurethanes, non-urethane polyether polymers, polysaccharides and derivatives thereof.
